(19) United States
(12) Patent Application Publication
(10) Pub. No.: US 2016/0212010 A1
(43) Pub. Date: Jul. 21, 2016

(54) NODE DEVICE, NETWORK SYSTEM, AND CONNECTION METHOD FOR NODE DEVICES

(71) Applicant: KABUSHIKI KAISHA TOSHIBA, Tokyo (JP)

(72) Inventor: Yoshihiro OBA, Kawasaki (JP)

(21) Appl. No.: 14/978,552

(22) Filed: Dec. 22, 2015

(30) Foreign Application Priority Data
Jan. 21, 2015 (JP) 2015-009859

(51) Int. Cl. H04L 12/24; H04L 29/06; H04W 12/08; H04W 40/24

(52) U.S. Cl. CPC H04L 41/0803; H04W 40/244; H04L 63/101; H04W 12/08; H04W 84/18

(57) ABSTRACT

According to an embodiment, a node device is connectible to a mesh network. The node device includes a selector, an establisher, a communicating unit, and a reselector. The selector selects a node serving as a connection-destination candidate node from among neighboring nodes. The establisher establishes a security association with the node selected by the selector. The communicating unit receives a connection-destination candidate node list via the node with which the establisher establishes the security association. The reselector newly selects a connection-destination node on the basis of the connection-destination candidate node list received by the communicating unit.

### CROSS-REFERENCE TO RELATED APPLICATION(S)

This application is based upon and claims the benefit of priority from Japanese Patent Application No. 2015-009859, filed on Jan. 21, 2015; the entire contents of which are incorporated herein by reference.

### FIELD

An embodiment described herein relates generally to a node device, a network system, and a connection method for node devices.

### BACKGROUND

Typically, a communication method is known that enables mutual connection among various devices and sensors.

However, typically, as against a mesh network in which path control messages are encrypted and can be exchanged only via such neighboring nodes with which security associations are established, protection by means of data confidency, message authentication code provision, or encryption using a digital signature is generally not provided to beacon frames. That leaves the beacon frames vulnerable to misrepresentation by an attacker.

For that reason, in practice, regardless of the fact that neighboring nodes having smaller rank values than the concerned node are present, a destination oriented directed acyclic graph (DODAG) is likely to get constructed using the IPv6 routing protocol for low-power and lossy networks (RPL) without establishing connection with the neighboring nodes. Such a DODAG is likely not to be the most suitable DODAG.

### BRIEF DESCRIPTION OF THE DRAWINGS

FIG. 1 is a block diagram illustrating a brief overview of the functions of a node device according to am embodiment;

FIG. 2 is a schematic diagram that schematically illustrates a wireless mesh network in which the node device according to the embodiment attempts to participate;

FIG. 3 is a flowchart for explaining an example of the operations performed by the node device according to the embodiment;

FIG. 4 is a diagram illustrating the format of a beacon frame used in the node device;

FIG. 5 is a diagram illustrating an exemplary configuration of a request for a connection-destination candidate node list as issued by the node device;

FIG. 6 is a diagram illustrating a configuration of the connection-destination candidate node list;

FIG. 7 is a diagram illustrating an exemplary configuration of a neighboring-node management table;

FIG. 8 is a diagram illustrating an example of operations performed when a node selects a connection-destination node;

FIG. 9 is a diagram illustrating an example of operations performed when a node selects a connection-destination node;

FIG. 10 is a diagram illustrating an exemplary configuration of a DODAG management table; and

FIG. 11 is a diagram illustrating the DODAG management table of a DODAG root node.

### DETAILED DESCRIPTION

According to an embodiment, a node device is connectible to a mesh network. The node device includes a selector, an establisher, a communicating unit, and a reselector. The selector selects a node serving as a connection-destination candidate node from among neighboring nodes. The establishes establishes a security association with the node selected by the selector. The communicating unit receives a connection-destination candidate node list via the node with which the establisher establishes the security association. The reselector newly selects a connection-destination node on the basis of the connection-destination candidate node list received by the communicating unit.

An embodiment of a node device is described below in detail with reference to the accompanying drawings.

### EMBODIMENT

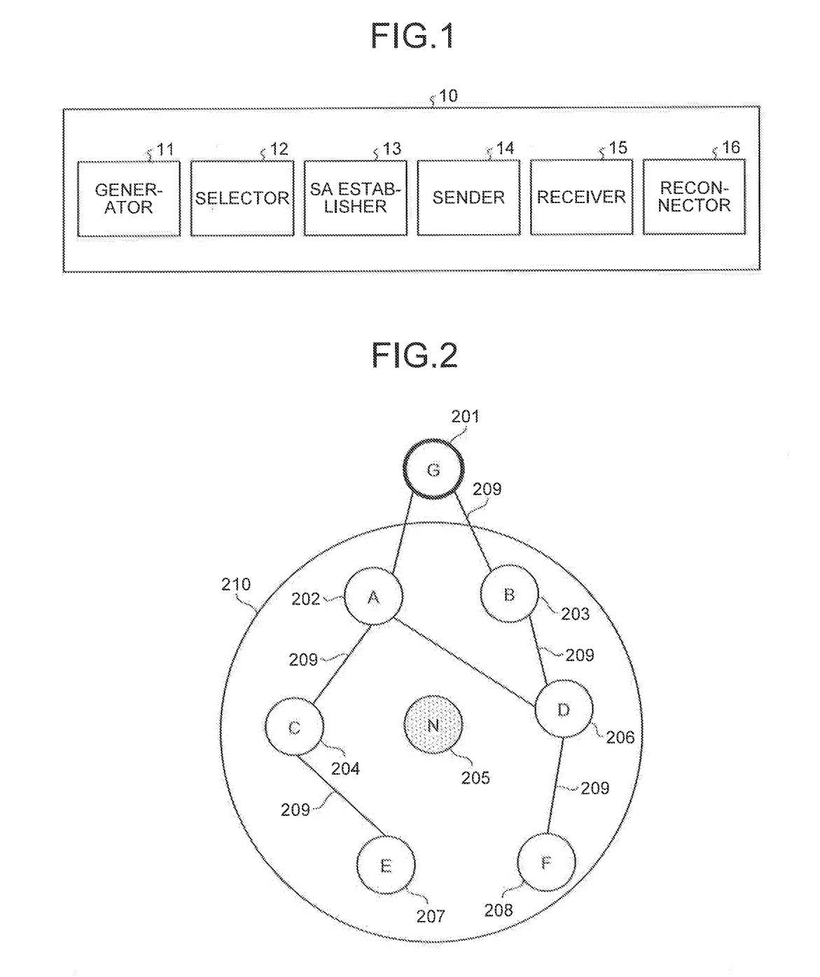

FIG. 1 is a block diagram illustrating a brief overview of the functions of a node device 10 according to the embodiment. Herein, the node device 10 is implemented using a computer that includes a central processing unit (CPU), a memory device, and a communication function.

As illustrated in FIG. 1, for example, the node device 10 includes a generator 11, a selector 12, a security association (SA) establisher 13, a sender 14, a receiver 15, and a reconnector (reselector) 16. These functions of the node device 10 can be implemented either using hardware circuitry or using software executed by the CPU.

The generator 11 generates a neighboring-node list using information on beacon frames received from the neighboring nodes by the receiver 15. The selector 12 arbitrarily selects, from the neighboring-node list generated by the generator 11, connection-destination nodes serving as candidate nodes for establishing connection.

The SA establisher (an establisher) 13 actively establishes a security association (SA) with respect to each of the unconnected connection-destination nodes selected by the selector 12. That is, the SA establisher 13 does not establish a security association with all neighboring connection-destination nodes that are not connected. Herein, for example, the SA establisher 13 uses a key exchange protocol such as HIP-DEX (which stands for Host identity Protocol-Diet Exchange) for establishing security associations.

The sender 14 has a wireless communication function for sending frames (including beacons) to the neighboring nodes and for transmitting messages. Moreover, for example, via one of the connection-destination nodes connected using the information included in the received beacons, the sender 14 sends a request for a connection-destination candidate node list using the security association established by the SA establisher 13. That is, the sender 14 sends a request for a connection-destination candidate node list via a node with which the SA establisher 13 has established the security association.

The receiver 15 has a wireless communication function for receiving frames (including beacons) from the neighboring nodes and for obtaining messages. Moreover, for example, via one of the connection-destination nodes connected using the information included in the received beacons, the receiver 15 receives a connection-destination candidate node list using the security association established by the SA establisher 13. That is, in response to a request sent by the sender 14 for a connection-destination candidate node list, the receiver 15 receives a connection-destination candidate node list. Meanwhile, the sender 14 and the receiver 15 are sometimes collectively referred to as a single communicating unit.

The reconnector 16 reselects the connection-destination nodes by using the connection-destination candidate node list received by the receiver 15, and establishes connection with respect to (i.e., reconnects with) the reselected connection-destination nodes. At that time, the reconnector 16 can use the connection-destination candidate node list as well as a neighboring-node management table (described later). Meanwhile, when the number of security associations reaches a predetermined upper limit, the reconnector 16 can preferentially delete the security associations that are established with the connection-destination nodes having large rank values.

Thus, for example, the node device 10 establishes a security association with at least a single selected connection-destination node from among the neighboring nodes connected to a mesh network. Then, the node device 10 uses the connection-destination candidate node list, which is received using the security association via any one of the connection-destination nodes, and newly selects at least a single connection-destination node from the neighboring nodes. Meanwhile, as the security associations, the node device 10 uses the security associations of the data link layer established among the neighboring nodes. At that time, the messages communicated using the security associations of the data link layer are all protected in a cryptographic manner with a link layer cryptographic key corresponding to the security associations. Moreover, as the rank values, the node device 10 uses the values obtained by multiplying, for example, 100 to the number of hops from the root node.

FIG. 2 is a schematic diagram that schematically illustrates a wireless mesh network with which the node device 10 according to the embodiment attempts to establish connection (to participate).

A node 201 (a node G) represents a DODAG root node (DODAG stands for Destination Oriented Directed Acyclic Graph). Moreover, nodes 202 to 208 (nodes A to F, and a node N) are nodes other than the DODAG root node and, for example, have the functions illustrated in FIG. 1. Meanwhile, in FIG. 2, the node 205 (the node N) represents the node device 10 that attempts to newly participate in the wireless mesh network. Moreover, SAs 209 represent the security associations established with neighboring nodes. Furthermore, an area 210 represents the wireless coverage (the wireless functionality applicable range) of the node 205 (the node N).

Since the node 205 (the node N) attempts to newly participate in the wireless mesh network, the SAs 209 corresponding to the node 205 are not yet established with any of the nodes in the wireless mesh network. Herein, the node 205 has the following neighboring nodes: the node 202 (the node A), the node 203 (the node B), the node 204 (the node C), the node 206 (the node D), the node 207 (the node E), and the node 208 (the node F).

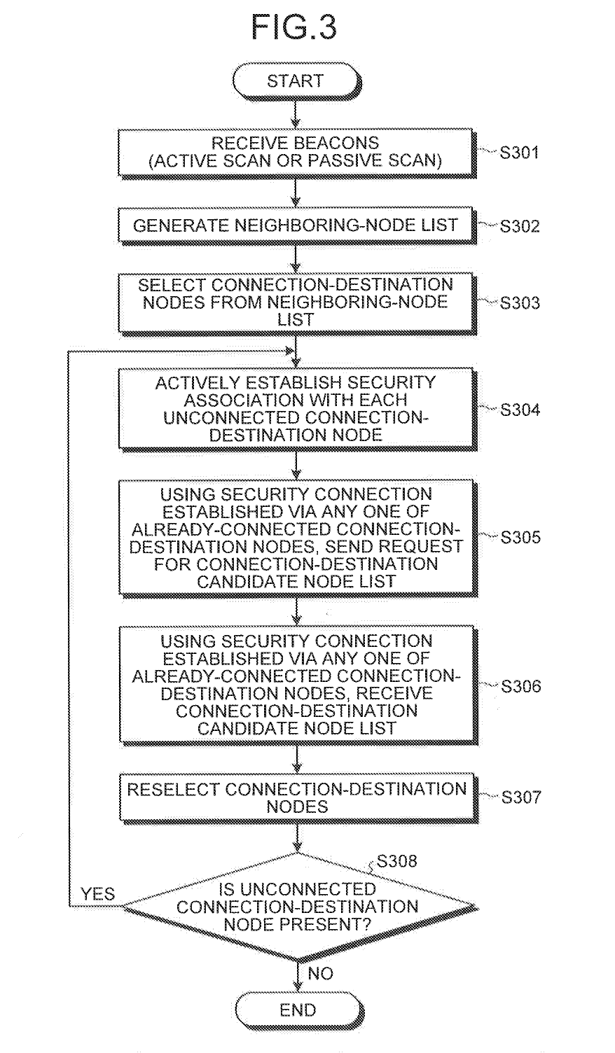

FIG. 3 is a flowchart for explaining an example of the operations performed by the node device 10 (the node 205) that attempts to newly participate in the wireless mesh network. As illustrated in FIG. 3, in the node 205, the receiver 15 receives beacon frames from the neighboring nodes (S301).

For example, in the node 205, the sender 14 broadcasts a beacon frame request, and the receiver 15 receives beacon frames in response (active scan). Alternatively, the beacon frames may be periodically broadcasted from the neighboring nodes (passive scan). Still alternatively, the active scan and the passive scan can be performed continuously for a predetermined period of time, or can include communication of frames other than beacons.

Then, in the node 205, the generator 11 generates a neighboring-node list using the information about the beacon frames received by the receiver 15 (S302). Subsequently, in the node 205, the selector 12 selects the connection-destination nodes from the neighboring node list (S303), and the SA establisher 13 establishes a security association with each unconnected connection-destination node (S304).

Then, in the node 205, the sender 14 sends, via any one of the already-connected connection-destination nodes, a request for a connection-destination candidate node list using the SAs 209 established by the SA establisher 13 (S305); and the receiver 15 receives the connection-destination candidate node list using the SAs 209 established by the SA establisher 13 (S306).

Subsequently, in the node 205, the reconnector 16 refers to the connection-destination candidate node list received by the receiver 15 and reselects the connection-destination nodes (3307). At that time, the reconnector 16 can refer to the connection-destination candidate node list as well as a neighboring-node management table (described later).

Then, in the node 205, the reconnector 16 determines whether or not any unconnected connection-destination node is present (S308). If any unconnected connection-destination node is present (Yes at S308), then the system control proceeds to S304. However, if no unconnected connection-destination node is present (No at S308), it marks the end of the operations. Meanwhile, as described above, when the number of security associations reaches a predetermined upper limit, the reconnector 16 can preferentially delete the SAs 209 that are established with the connect ion-destination nodes having large rank values.

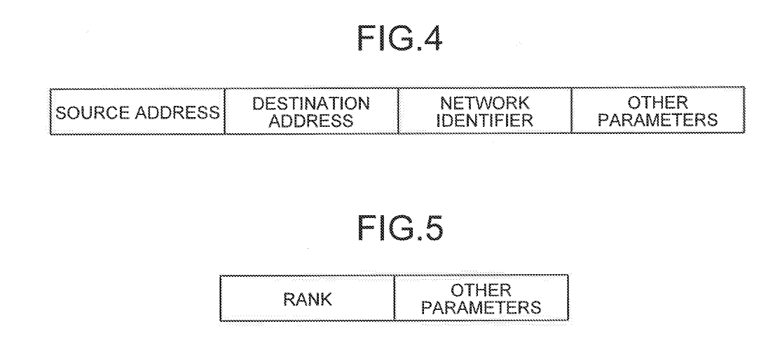

FIG. 4 is a diagram illustrating the format of a beacon frame used in the node device 10 (such as the node 205). As illustrated in FIG. 4, a beacon frame includes a source address, a destination address, a network identifier, and other parameters.

The node device 10 recognizes, as a neighboring node, a node corresponding to the source address specified in a beacon frame that is received by the receiver 15 at a received power equal to or greater than a predetermined level. Regarding the destination address, during the active scan, the source address of a beacon frame request is set as the destination address; and during the passive scan, a broadcast address is set as the destination address.

FIG. 5 is a diagram illustrating an exemplary configuration of a request for a connection-destination candidate node list as issued by the sender 14 of the node device 10. The request for a connect ion-destination candidate node list includes the rank (the rank value) of the source node in the IPv6 routing protocol for low-power and lossy networks (RPL) and includes the other parameters. Herein, the other parameters are arbitrary. Meanwhile, the request for a connection-destination candidate node list can be included in an IPv6 packet sent to the DODAG root node or can be included in an IPv6 packet that is sent to a DODAG parent node and is transferred in a hop-by-hop manner in the DODAG up to the DODAG root node. Moreover, the request for a connection-destination candidate node list can also include the identifier of the source node.

Examples of the former case include a DAO message (DAO stands for Destination Advertisement Object) of the RPL running in a non-storing mode and an ICMPv6 Echo Reply packet. Examples of the latter case include a DAO message of the RPL running in a storing mode.

The rank is set to the rank value of the source node of the request for a connection-destination candidate node list. Meanwhile, as the rank of the request for a connection-destination candidate node list, the node device 10 can make use of the SenderRank field in the RPL options defined in RFC6553. The rank included in the request for a connection-detection candidate node list is stored by the DODAG root node.

The other parameters may include the maximum number of candidates, RPL InstanceID, DODAGID, and position information of the source node. The number of maximum candidates includes the greatest value of the number of connection-destination candidate nodes included in the connection-destination candidate node list. The neighboring-node list includes one or more neighboring nodes of the node that generates the request for a connection-destination candidate node list. Moreover, RPL InstanceID and DODAGID are defined in RFC6550. Furthermore, the position information represents position information of the node that generated the request for a connection-destination candidate node list (i.e., the source node).

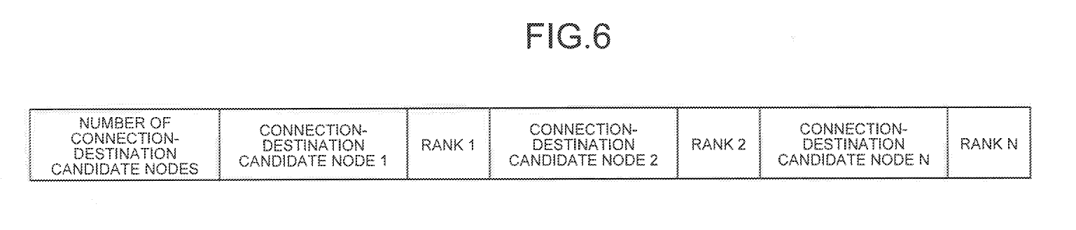

FIG. 6 is a diagram illustrating a configuration of the connection-destination candidate node list. Herein, the connection-destination candidate node list includes the number of connection-destination candidate nodes (referred to as N), a connection-destination candidate node 1 and a rank 1, a connection-destination candidate node 2 and a rank 2, . . . , and a connection-destination candidate node N and a rank N. In each of the connection-destination candidate node 1, the connection-destination candidate node 2, . . . , and the connection-destination candidate node N is set an address that serves as the identifier of the corresponding connection-destination candidate node. In the rank 1, the rank 2, . . . , and the rank N are respectively set the rank values of the connection-destination candidate node 1, the connection-destination candidate node 2, . . . , and the connection-destination candidate node N, respectively, in the RPL. Meanwhile, there are times when the rank 1, the rank 2, . . . , and the rank N are all smaller than the rank included in the request for a connection-destination candidate node list.

The connection-destination candidate node list is sent to the node that, issued the request for a connection-destination candidate node list. The connection-destination candidate node list can be included in an arbitrary IPv6 packet, such as a DAO-ACK (DAO-acknowledgement) message of the RPL or an ICMPv6 Echo Reply packet, sent to the node that issued the request for a connection-destination candidate node list.

When the connection-destination candidate node list is included in a DAO-ACK message, in the DODAG in which the non-storing mode of the RPL is implemented, the node that issued the request for a connection-destination candidate node list represents the node that generated the request for a connection-destination candidate node list.

On the other hand, in the DODAG in which the storing mode of the RPL is implemented, the node that issued the request for a connection-destination candidate node list represents an RPL child node. The connection-destination candidate node list is transferred in a hop-by-hop manner in the downstream direction of the DODAG up to the node that generated the request for a connection-destination candidate node list.

Meanwhile, if the connection-destination candidate node 1, the connection-destination candidate node 2, . . . , and the connection-destination candidate node N are sorted according to the rank values; then the rank 1, the rank 2, , . . . , and the rank N may be omitted. As the connection-destination candidate node list, it is possible to use a RPL routing header defined in RFC6554. In that case, the connection-destination candidate node list included in the RPL routing header is sorted in ascending order of rank values; and the rank 1, the rank 2, . . . , and the rank N are omitted. In the DODAG in which the non-storing mode of the RPL is implemented, the RPL routing header is attached to a DAO-ACK message that is sent to the nodes which are separated from the RPL root node by two or more hops.

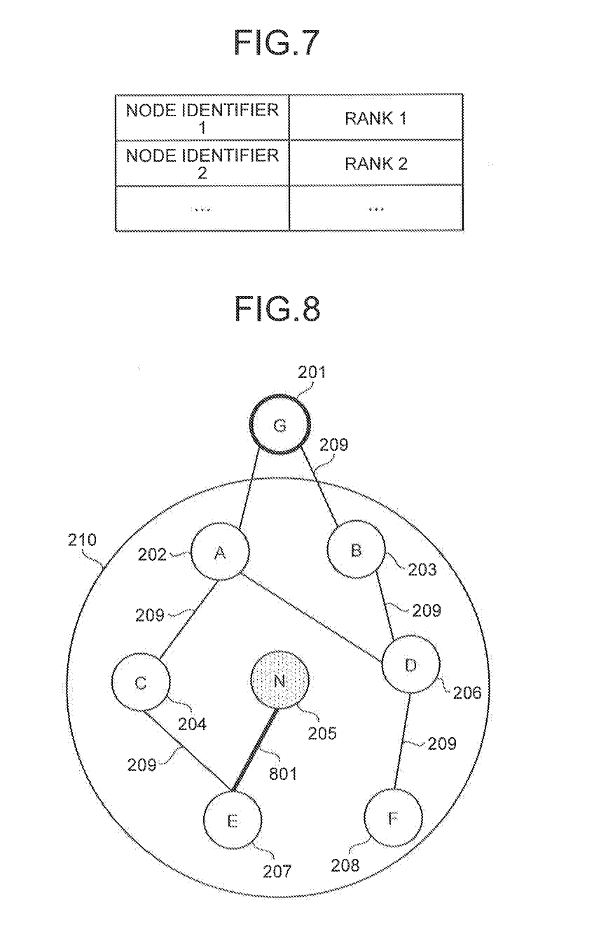

Given below is the explanation about an exemplary configuration of the neighboring-node management table that is managed by the node 202 (the node A). FIG. 7 is a diagram illustrating an exemplary configuration of the neighboring-node management table that is managed by the node 202 (the node A). In the neighboring-node management table, each entry includes a node identifier and a rank. For example, in the neighboring-node management table for the node 202 (the node A) illustrated in FIG. 2, there are entries for the node 201 (the node G), the node 204 (the node C), and the node 206 (the node D).

The node 201 (the node G) is the RPL parent node. The node 204 (the node C) and the node 206 (the node D) are the RPL child nodes. In the RPL, the rank values for only DODAG parent nodes are managed. Hence, for example, the rank for the node 201 (the node G) is 100; while the entries for the node 204 (the node C) and the node 206 (the node D) do not have the ranks set therein.

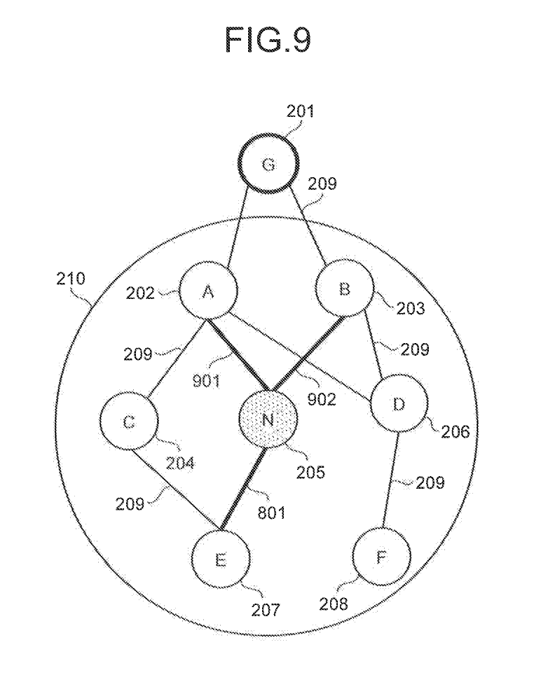

Given below is the explanation about an example of operations performed in the case in which the node device 10 selects a connection-destination node. FIGS. 8 and 9 are diagrams illustrating an example of operations performed when the node 205 (the node N) selects the node 207 (the node E) as a connection-destination node. Herein, the request for a connection-destination candidate node list is included in a DAO message (DAO stands for Destination Advertisement Object) of the RPL, and the non-storing mode of the RPL is implemented.

As illustrated in FIG. 8, the node 205 (the node N) establishes an SA 801 with the node 207 (the node E). At that time, in the neighboring-node management table for the node 205 (the node N), an entry is created without setting the rank for the node 207 (the node E). The node 205 (the node N) exchanges RPL messages using the SA 801 via the node 207 (the node E). As a result, the rank value of the node 205 (the node N) becomes equal to 400 (=4*100).

At that time, in the neighboring-node management table for the node 205 (the node N), the entry for the node E has the rank changed to 300. Then, the node 205 (the node N) sends, to the DODAG root node 201 (the node G), a DAO message including a request for a connection-destination candidate node list.

If the maximum number of candidates of the connection-destination candidate node list is two, then the request for a connection-destination candidate node list (rank, 2, neighboring-node list) becomes equal to (400, 2, {A, B, C, D, E, F}). Upon receiving the DAO message, the DODAG root node 201 (the node G) uses a DODAG management table (described later); processes the request for a connection-destination candidate node list as specified in the DAO message; and sends a DAO-ACK message, which includes the connection-destination candidate node list, to the node 205 (the node N).

The connection-destination candidate node list (the number of connection-destination candidate nodes, connection-destination candidate node 1, rank 1, connection-destination candidate node 2, rank 2) becomes equal to (2, A, 100, B, 100). The node 205 (the node N) that receives the DAO-ACK message processes the connection-destination candidate node list included in the DAO-ACK message and reselects the connection-destination nodes.

As a result, as illustrated in FIG. 9, the node 202 (the node A) and the node 203 (the node B) are set as the new connection-destination nodes for the node 205 (the node N). Thus, the node 205 (the node N) establishes SAs 301 and 902 with those nodes. At that time, in the neighboring-node management table for the node 205 (the node N), entries having no setting of the ranks are added with respect to the node 202 (the node A) and the node 203 (the node B).

Then, the node 205 (the node N) exchanges RPL messages via the node 202 (the node A) and the node 203 (the node B). As a result, in the neighboring-node management table for the node 205, the entries for the node 202 (the node A) and the node 203 (the node B) have the ranks set to 100.

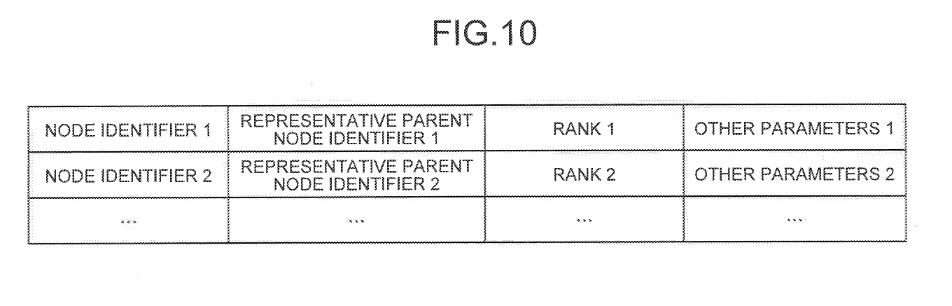

Given below is the explanation of an exemplary configuration of the DODAG management table held by the DODAG root node (the node 201). FIG. 10 is a diagram illustrating an exemplary configuration of the DODAG management table held by the DODAG root node (the node 201). The DODAG management table is managed for each DODAG. Each record in the DODAG management table includes a node identifier, a representative parent node identifier, a rank, and other parameters. Herein, the other parameters are set in an arbitrary manner. The representative parent node is one of the nodes having the smallest rank value from among one or more parent nodes; and represents the most preferred parent in the RPL. The other parameters may include the position information of the nodes corresponding to the node identifiers.

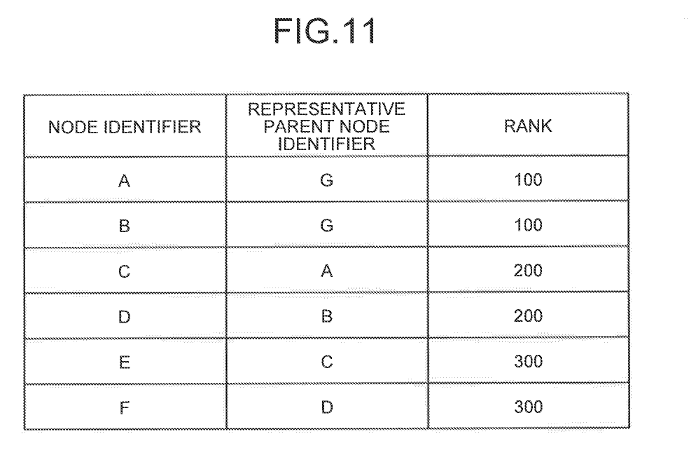

FIG. 11 is a diagram illustrating the DODAG management table of the DODAG root node (the node 201) with respect to the topology illustrated in FIG. 2. As illustrated in FIG. 11, in the DODAG management table of the DODAG root node, each node has the representative parent node identifier and the rank associated thereto.

Meanwhile, if the functions of the node device 10 are configured with a computer program, then that computer program can be installed in advance in the node device 10 having the functionality of a computer, or can be stored in a memory medium such as a compact disk read only memory (CD-ROM), or can be distributed via a network.

In this way, in the node device 10, the selector 12 selects the connection-destination candidate nodes from among the neighboring nodes. Then, the SA establisher 13 establishes security associations with the nodes selected by the selector 12. Subsequently, the receiver 15 receives a connection-destination candidate node list via a node with which the SA establisher 13 establishes the security association. Then, on the basis of the connection-destination candidate node list received by the receiver 15, the reconnector 16 newly selects the connection-destination nodes. As a result, a secure DODAG can be built with efficiency.

While a certain embodiment has been described, the embodiment has been presented by way of example only, and is not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. A node device that is connectible to a mesh network, comprising:
a selector to select a node serving as a connection-destination candidate node from among neighboring nodes;
an establisher to establish a security association with the node selected by the selector;
a communicating unit to receive a connection-destination candidate node list via the node with which the establisher establishes the security association; and
a reselector to newly select a connection-destination node on the basis of the connection-destination candidate node list received by the communicating unit.

2. The device according to claim 1, wherein the communicating unit
sends a request for a connection-destination candidate node list via the node with which the establisher establishes the security association, and
receives a connection-destination candidate node list in response to the request for a connection-destination candidate node list.

3. The device according to claim 1, wherein the communicating unit receives a connection-destination candidate node list that at least includes an identifier of the connection-destination candidate node and a rank value of RPL corresponding to the connection-destination candidate node.

4. The device according to claim 2, wherein the communicating unit sends a request for a connection-destination candidate node list that includes an identifier of source node and a rank value of RPL corresponding to the source node.

5. The device according to claim 2, wherein the communication unit sends a request for a connection-destination candidate node list that includes position information of source node.

6. The device according to claim 2, wherein the communication unit sends a request for a connection-destination candidate node list to a DODAG root node.

7. A network system that forms a mesh network, comprising:
a DODAG root node of RPL; and
a node device that is connectible to the DODAG root node via one of a plurality of other nodes, wherein
the node device includes
a selector to select a node serving as a connection-destination candidate node from among neighboring nodes,
an establisher to establish a security association with the node selected by the selector,
a communicating unit to receive a connection-destination candidate node list via the node with which the establisher establishes the security association, and
a reselector to newly select a connection-destination node on the basis of the connection-destination candidate node list received by the communicating unit.

8. A connection method for connecting a node device to a mesh network, the method comprising:
selecting a node serving as a connection-destination candidate node from among neighboring nodes;
establishing a security association with the selected node;
receiving a connection-destination candidate node list via the node with which the security association is established; and
newly selecting a connection-destination node on the basis of the connection-destination candidate node list which is received.
